(19) United States
(12) Patent Application Publication
(10) Pub. No.: US 2004/0161967 A1
(43) Pub. Date: Aug. 19, 2004

(54) GPS transceiver

(76) Inventor: Huei-Huang Tsai, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/760,361

(22) Filed: Jan. 21, 2004

(30) Foreign Application Priority Data
Feb. 18, 2003 (TW) 92202504

(51) Int. Cl. H01R 11/00

(52) U.S. Cl. 439/502

(57) ABSTRACT

A GPS transceiver is disclosed and including a GPS receiver and a transmitter coupled to the GPS receiver via a coupler. The transmitter can be detachably coupled with the coupler and replaced depending on the type of the electronic device to which the GPS receiver is connected, so that the GSP receiver can be compatible with various data transmission interfaces to receive data transmitted from a satellite. In this manner, the data related to the longitude and latitude of the location of the GPS receiver can be acquired and outputted to the electronic device coupled to which the GPS receiver connects.

### FIELD OF THE INVENTION

The present invention is r elated to a GPS (global positioning system) transceiver, and more particularly to a GPS transceiver capable of compatibly supporting various data transmission interfaces.

### BACKGROUND OF THE INVENTION

The global positioning system, as well known as GPS, has been popularized as a personalized commodity. At first GPS was developed for use with aircraft and ship, and was designed for the purpose of calibration and military action. However, GPS is now widely disposed on an automobile as a traffic navigation system. An automobile provided with GPS device can let a GPS receiver to receive satellite signals and show the location of the automobile on a display screen by processing the received satellite signals through the computations of a microprocessor, and help the driver find out the location of the destination, the optimum route to reach the destination and the distance between the current location of the automobile and the destination through the use of electronic map data. Therefore, the disturbance caused by the unawareness of the location can be eliminated effectively. The advantages of GPS also promote the spreading of GPS device. Moreover, GPS has been combined with mobile computer and portable digital assistant (PDA) because of the prevalence of portable electronic device, which can be used as a rescue and salvage kit when a person is in peril during hiking or traveling.

Unfortunately, most of the current GPS device can only be mounted onto a fixed interface, for example, a GPS receiver can be mounted onto a mobile computer, but can not be mounted onto a PDA device. Thus the applicability of GPS is limited. More disadvantageously, GPS device is known as a device-dependent utility, that is, a user has to purchase different type of GPS receives for different type of electronic devices. As a result, the cost incurred with the usage of GPS device has been increased significantly.

Therefore, the present invention provides a GPS transceiver that can remove the drawbacks of current GPS receiver, facilitate its convenience and further lower its budget.

### SUMMARY OF THE INVENTION

A primary object of the present invention is to provide a GPS transceiver capable of compatibly supporting various data transmission interfaces.

A secondary object of the present invention is to provide a GPS transceiver provided with a portable external-type antenna device to achieve a greater portability.

To attain a GPS transceiver fulfilling the above objects, the GPS transceiver according to the present invention is comprised of a GPS receiver including a coupler, and a transmitter mounted onto the GPS receiver by the coupler. The transmitter is capable of processing the data received by the GPS receiver and outputting the processing result to a personal computer, a mobile computer or a PDA device connected thereto, wherein the transmitter can be a transmission interface device or a transmission interface adapting device. The transmitter can be replaced depending on the type of the electronic device to which the GPS receiver connects. The transmitter interface device includes an I/O port and a memory device for inputting/outputting data and storing data.

The foregoing and features and advantages of the present invention will become more apparent through the following descriptions with reference to the accompanying drawings, in which:

### BRIEF DESCRIPTION OF THE DRAWINGS

FIG. 1 is a structural view of a GPS transceiver according to a preferred embodiment of the present invention;

FIG. 2 is a structural view of a GPS transceiver according to another preferred embodiment of the present invention;

FIG. 3 shows the GPS transceiver being mounted onto a mobile computer according to a preferred embodiment of the present invention;

FIG. 4 is a structural view of a GPS transceiver according to another yet preferred embodiment of the present invention;

FIG. 5 is an exploded view showing a GPS transceiver being coupled to a PDA device according to another yet preferred embodiment of the present invention;

FIG. 6(A) shows an external-type antenna device being detached from the GPS receiver according to the present invention; and

FIG. 6(B) shows an external-type antenna device being coupled to the GPS receiver according to the present invention.

### DETAILED DESCRIPTION OF THE PREFERRED EMBODIMENT

FIG. 1 is a structural view of a GPS transceiver according to a preferred embodiment of the present invention. As shown in FIG. 1, a GPS transceiver 10 includes a GPS receiver 12 and a transmission interface device 14, wherein the GPS receiver 12 provides a transmission port 16 and the transmission interface 14 provides a coupler 18 being arranged correspondingly to the transmission port 16. With the cooperation of the transmission port 16 and the coupler 18, the transmission interface device 14 can be coupled to or detached from the GPS receiver 12, wherein the transmission interface device 14 is compatible with the transmission interface of a personal computer, a mobile computer, a personal digital assistant (PDA), or other data transmission interfaces, such as PCMCIA interface, CF (compact flash) card interface, SD (security digital) card interface, and MMC (multimedia card) interface. In this way, the GPS receiver 12 can receive the data transmitted from the satellite to acquire the longitudinal and latitudinal information about its current location, and then the received data can be transmitted to a personal computer, a mobile computer or a PDA device by the transmission interface device 14. In addition, the transmission interface device 14 includes an I/O port and a memory device for inputting/outputting data and storing data so as to monitor the motion of an automobile.

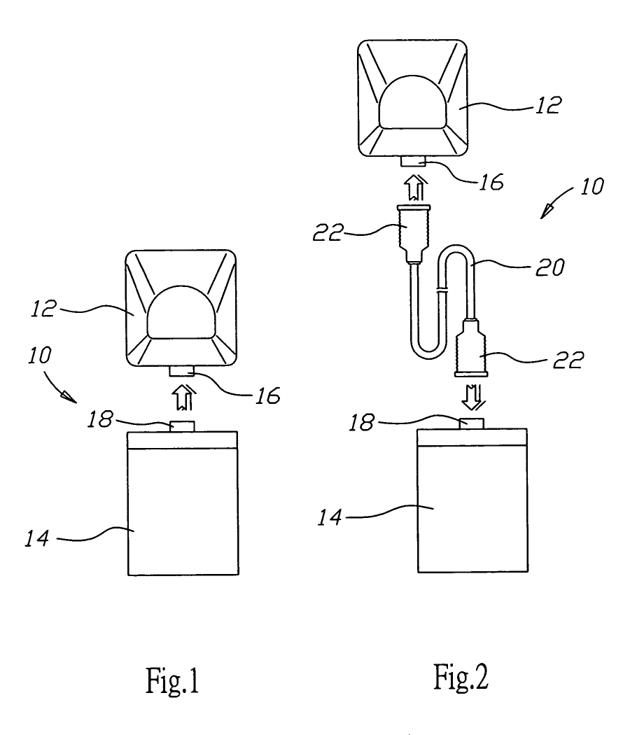

FIG. 2 is a structural view of a GPS transceiver according to another preferred embodiment of the present invention. As shown in FIG. 2, a transmission cable 20 is interlinked between the transmission port 16 and the coupler 18. A connection port 22 is respectively fastened with one end of the transmission cable 20 in order to interlink the transmission port 16 and the coupler 18 by the transmission cable 20. With the incorporation of the transmission cable 20, the receivable range of the GPS-receiver 12 can be extended so that the resolution of the data received from the GPS satellite to the GPS receiver 12 can be improved by positioning the GPS receiver in an appropriate location.

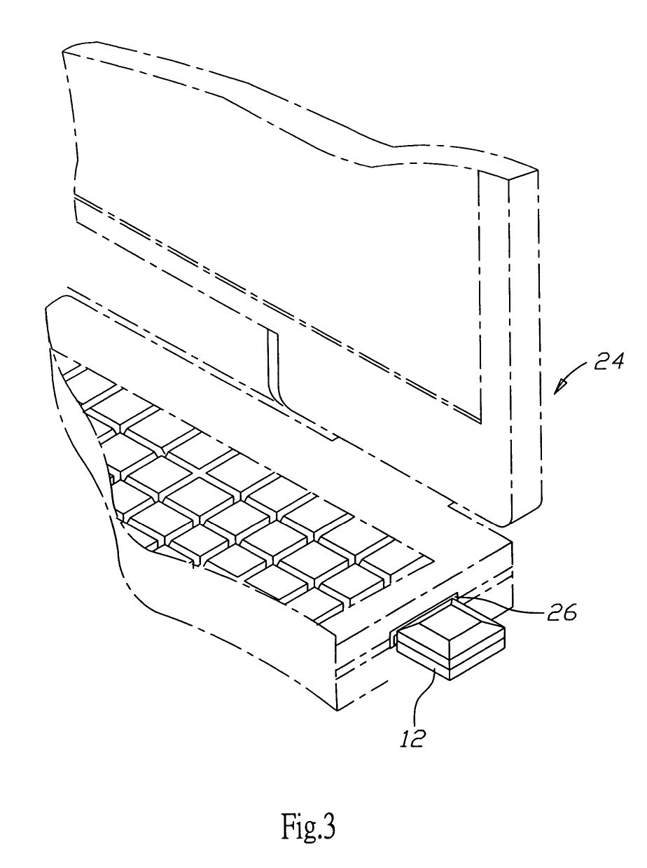

FIG. 3 shows the GPS transceiver 10 being installed onto a mobile computer 24 by inserting the transmission interface device 14 into the I/O port slot 26 of the mobile computer 24. Under this condition, the GPS receiver 12 can acquire the longitudinal and latitudinal information about its location and output the longitudinal and latitudinal information to the mobile computer 24. With the aid of GPS receiver software of the mobile computer 24, the location of the GSP receiver 12 can be easily traced, and the location of the destination, the optimum route to reach the destination and the distance between the current location and the destination can be realized through the use of electronic map data. In addition, the transmission interface device 14 is capable of inputting/outputting data and storing data, so that the GPS transceiver 10 can be used to monitor the motion of an automobile. For example, the transmission interface device 14 can preload the data related to the route that the automobile will take today in advance, and then the transmission interface device 14 can be removed and the data related to the route that the automobile will take today can be read out by a car computer or other data reader, while the route of the automobile today can be monitored.

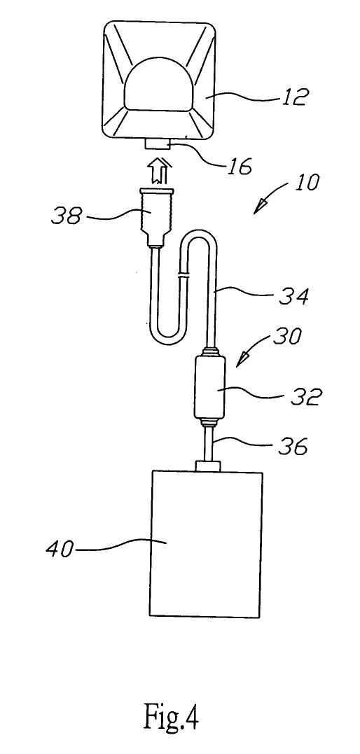

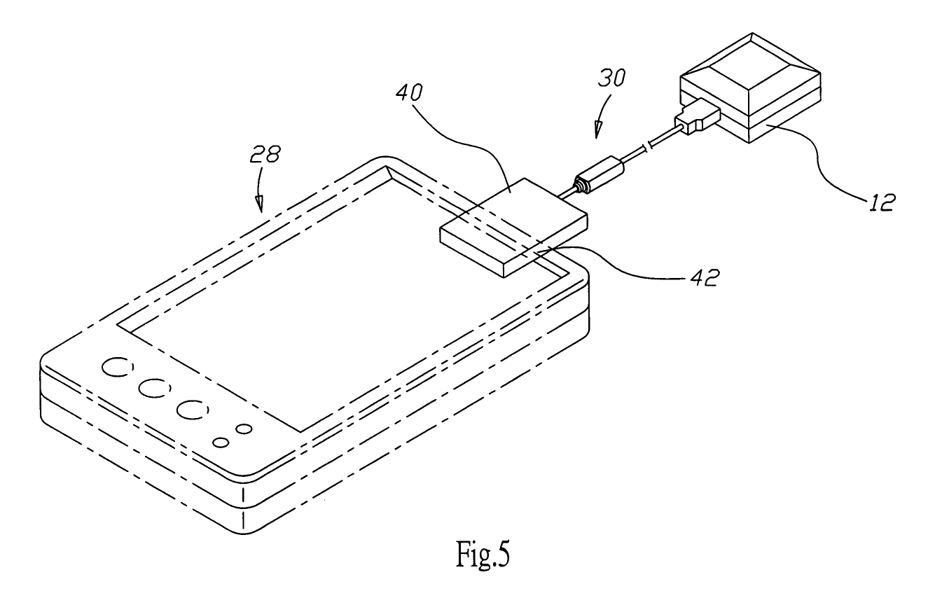

Referring to FIGS. 4 and 5, when the GPS receiver 12 is desired to be mounted onto various electronic devices, for example, a PDA 28, the installing steps are as simple as to replace the transmission interface device 14 with a transmission interface adapting device 30, which includes an adapter 32 with each end fastened with a cable 34 and 36. One end of the cable 34 is fastened with a connection port 38, and one end of the cable 36 is fastened with a transmission interface device 40. The connection port 38 can be fixedly coupled to the coupler 36 of the GPS receiver 12. Because the transmission interface device 40 can compatibly support the data transmission interface of the PDA device 28, the transmission interface device 40 can be inserted in the interface slot 42 of the PDA device 28. The GPS receiver 12 can be universally suitable for use with various electronic devices by replacing the transmission interface device 14 and transmission interface adapting device 30 according to the type of the electronic device coupled thereto. In addition, the transmission interface device 40 further includes an I/O port and a memory device.

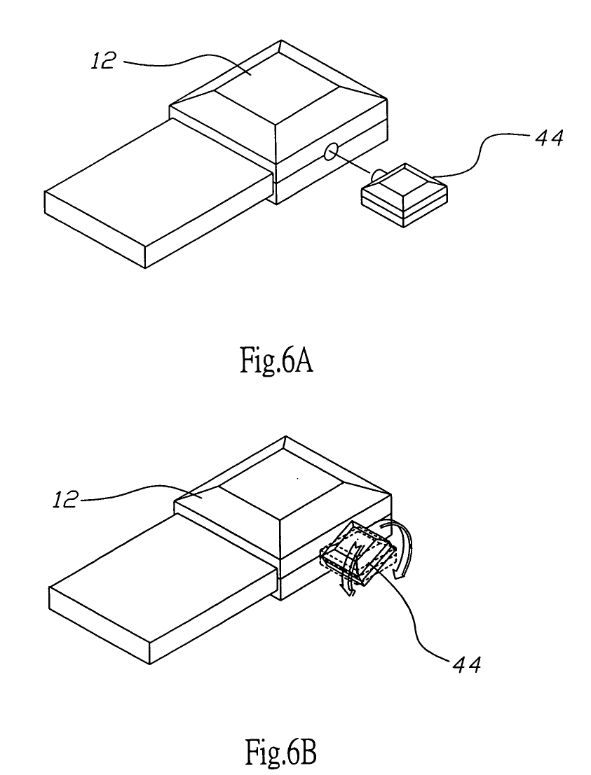

FIGS. 6(A) and 6(B) respectively show an external-type antenna device being coupled to and detached from the GPS receiver according to the present invention. As shown, the GPS receiver 12 can further combine an external type antenna device 44 so as to extend its versatility.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A global positioning system (GPS) transceiver including a GPS receiver having a coupler and a transmitter, wherein the transmitter is detachably coupled to the GPS receiver via the coupler, and the GPS receiver is used to receive data from a satellite to acquire data related to the longitude and latitude of its location, and the transmitter is used to output the data related to the longitude and latitude of its location.

2. The global positioning system (GPS) transceiver according to claim 1 wherein the transmitter is a transmission interface device with one end thereof is fastened with a connection port corresponding to the coupler.

3. The global positioning system (GPS) transceiver according to claim 2 wherein the transmission interface device is one of a PCMCIA interface, a compact flash card interface, a security digital card interface, a multimedia card interface, a data transmission interface adapted for a personal computer, a data transmission interface adapted for a mobile computer, and a data transmission interface adapted for a personal digital assistance.

4. The global positioning system (GPS) transceiver according to claim 2 further comprising a cable with each end thereof fastened with a connection port for interlinking the connection port of the transmission interface and the coupler.

5. The global positioning system (GPS) transceiver according to claim 1 wherein the transmitter is a transmission interface adapting device including an adapter with each end thereof fastened with a cable, wherein one of the cables fastened to the adapter is fastened with a connection port corresponding to the coupler and the other one of the cables fastened to the adapter is fastened with the transmission interface device.

6. The global positioning system (GPS) transceiver according to claim 5 wherein the transmission interface device is one of a PCMCIA interface, a compact flash card interface, a security digital card interface, a multimedia card interface, a data transmission interface adapted for a personal computer, a data transmission interface adapted for a mobile computer, and a data transmission interface adapted for a personal digital assistance.

7. The global positioning system (GPS) transceiver according to claim 1 wherein the GPS receiver is further coupled with an antenna device.

8. The global positioning system (GPS) transceiver according to claim 2 wherein the transmission interface device includes an I/O port and a memory device.

9. The global positioning system (GPS) transceiver according to claim 5 wherein the transmission interface device includes an I/O port and a memory device.
